(19) United States
(12) Patent Application Publication
(10) Pub. No.: US 2026/0149862 A1
(43) Pub. Date: May 28, 2026

(54) CAMERA MODULE

(71) Applicant: Samsung Electro-Mechanics Co., Ltd., Suwon-si (KR)

(72) Inventor: Cheolmun KANG, Suwon-si (KR)

(73) Assignee: Samsung Electro-Mechanics Co., Ltd., Suwon-si (KR)

(21) Appl. No.: 19/068,658

(22) Filed: Mar. 3, 2025

(30) Foreign Application Priority Data
Nov. 28, 2024 (KR) 10-2024-0173133

(51) Int. Cl. H04N 23/54; H04N 23/51

(52) U.S. Cl. CPC H04N 23/54; H04N 23/51

(57) ABSTRACT

A camera module includes an image sensor configured to convert an incident light into an electric signal, a substrate electrically connected to the image sensor, and including a main circuit layer, and a reinforcing member configured to support the substrate, and having a strength reinforcing portion, wherein the main circuit layer includes a main signal layer forming a path for transferring signals, wherein the reinforcing member includes a first region and a second region having different thicknesses, and wherein the second region is located to overlap with the main signal layer in a vertical direction.

### CROSS-REFERENCE TO RELATED APPLICATIONS

This application claims the benefit under 35 USC 119(a) of Korean Patent Application No. 10-2024-0173133 filed on Nov. 28, 2024, in the Korean Intellectual Property Office, the entire disclosure of which is incorporated herein by reference for all purposes.

### BACKGROUND

### 1. Field

The present disclosure relates to a camera module.

### 2. Description of the Background

Efforts are currently being made to reduce the size of components mounted on electronic devices due to the trend toward miniaturization and slimming of portable electronic devices including mobile phones. In addition, technologies for integrating the functions of electronic components are continuously being researched and developed. In particular, camera modules, one of the electronic components, are being used in smartphones, laptop computers, and vehicles.

As video recording increases, the use of portable smartphone camera modules is increasing. Additionally, high-performance camera modules are required for vehicles to implement cutting-edge advanced driver-assistance systems (ADAS) for autonomous driving functions.

However, as camera modules become more pixel-rich and smaller, there is an increased risk of the camera module being damaged during manufacturing or use.

The above information is presented as background information only to assist with an understanding of the present disclosure. No determination has been made, and no assertion is made, as to whether any of the above might be applicable as prior art with regard to the disclosure.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a camera module includes an image sensor configured to convert an incident light into an electric signal, a substrate electrically connected to the image sensor, and including a main circuit layer, and a reinforcing member configured to support the substrate, and having a strength reinforcing portion, wherein the main circuit layer includes a main signal layer forming a path for transferring signals, wherein the reinforcing member includes a first region and a second region having different thicknesses, and wherein the second region is disposed to overlap with the main signal layer in a vertical direction.

The substrate may include an upper conductive layer disposed on an upper side of the main circuit layer, and the upper conductive layer may include an upper mesh layer.

The upper mesh layer may be disposed to overlap with the main signal layer and the second region of the reinforcing member in the vertical direction.

The substrate may include a lower conductive layer disposed on a lower side of the main circuit layer, and the lower conductive layer may include a lower mesh layer.

The lower mesh layer may be disposed to overlap with the main signal layer and the second region of the reinforcing member in the vertical direction.

A thickness of the first region may be thinner than a thickness of the second region.

A thickness of the first region may be thicker than a thickness of the second region.

The main circuit layer may further include a non-signal layer disposed around the main signal layer.

The non-signal layer may be grounded.

In another general aspect, a camera module includes an image sensor configured to convert an incident light into an electric signal, a substrate electrically connected to the image sensor, and a reinforcing member configured to support the substrate, and having a strength reinforcing portion, wherein the reinforcing member includes a first region and a second region having different thicknesses, and wherein an entire region of the first region and an entire region of the second region overlaps with the substrate in a vertical direction.

The substrate may include a main circuit layer, the main circuit layer may include a main signal layer forming a path for transferring signals, and the second region may be disposed to overlap with the main signal layer in the vertical direction.

A thickness of the first region may be thinner than a thickness of the second region.

A thickness of the first region may be thicker than a thickness of the second region.

In another general aspect, a camera module includes an image sensor configured to convert an incident light into an electric signal, a substrate electrically connected to the image sensor, and having a central region where an opening is formed, and a reinforcing member configured to support the substrate, and having a strength reinforcing portion, wherein the reinforcing member includes a first region and a second region having different thicknesses, and wherein a part of the first region overlaps with the substrate in a vertical direction, and a remainder of the first region overlaps with the opening in the vertical direction.

The substrate may include a main circuit layer, the main circuit layer may include a main signal layer forming a path for transferring signals, and the second region may be disposed to overlap with the main signal layer in the vertical direction.

Other features and aspects will be apparent from the following detailed description, the drawings, and the claims.

### BRIEF DESCRIPTION OF THE DRAWINGS

FIG. 1 is an exploded perspective view of a camera module according to an embodiment.

FIG. 2 is a drawing showing the reinforcing member of FIG. 1.

FIG. 3 is a drawing showing a substrate to which a reinforcing member is attached.

FIG. 4 is a cross-sectional view taken along line A-A′ of FIG. 3.

FIG. 5 is a drawing showing a reinforcing member according to another embodiment.

FIG. 6 is a drawing showing a substrate to which the reinforcing member of FIG. 5 is attached.

FIG. 7 is a cross-sectional view taken along line B-B′ of FIG. 6.

FIG. 8 is a drawing showing a camera module according to another embodiment.

Throughout the drawings and the detailed description, unless otherwise described, the same reference numerals refer to the same elements. The drawings may not be to scale, and the relative size, proportions, and depiction of elements in the drawings may be exaggerated for clarity, illustration, and convenience.

### DETAILED DESCRIPTION OF THE EMBODIMENTS

Hereinafter, while examples of the present disclosure will be described in detail with reference to the accompanying drawings, it is noted that examples are not limited to the same.

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of this disclosure. For example, the sequences of operations described herein are merely examples, and are not limited to those set forth herein, but may be changed as will be apparent after an understanding of this disclosure, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of this disclosure.

Throughout the specification, when an element, such as a layer, region, or substrate is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

As used herein, the term “and/or” includes any one and any combination of any two or more of the associated listed items; likewise, “at least one of” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Spatially relative terms, such as “above,” “upper,” “below,” “lower,” and the like, may be used herein for ease of description to describe one element's relationship to another element as shown in the figures. Such spatially relative terms are intended to encompass different orientations of the device in use or operation in addition to the orientation depicted in the figures. For example, if the device in the figures is turned over, an element described as being “above,” or “upper” relative to another element would then be “below,” or “lower” relative to the other element. Thus, the term “above” encompasses both the above and below orientations depending on the spatial orientation of the device. The device may also be oriented in other ways (rotated 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

Due to manufacturing techniques and/or tolerances, variations of the shapes shown in the drawings may occur. Thus, the examples described herein are not limited to the specific shapes shown in the drawings, but include changes in shape that occur during manufacturing.

Herein, it is noted that use of the term “may” with respect to an example, for example, as to what an example may include or implement, means that at least one example exists in which such a feature is included or implemented while all examples are not limited thereto.

The features of the examples described herein may be combined in various ways as will be apparent after an understanding of this disclosure. Further, although the examples described herein have a variety of configurations, other configurations are possible as will be apparent after an understanding of this disclosure.

Further, throughout the specification, the phrase “in a plan view” or “on a plane” means viewing a target portion from the top, and the phrase “in a cross-sectional view” or “on a cross-section” means viewing a cross-section formed by vertically cutting a target portion from the side.

The present disclosure may provide a camera module capable of preventing or minimizing distortion of the substrate.

However, the objective of the present disclosure is not limited to the aforementioned one, and may be extended in various ways within the spirit and scope of the present disclosure.

Hereinafter, an optical axis OA direction, which is a direction parallel to the central axis of a lens accommodated in a lens barrel 10, may mean the z-axis direction in the drawings. Also, the direction intersecting direction of the optical axis OA may mean the x-axis direction in the drawings, and the direction intersecting direction of the optical axis OA and the x-axis direction may mean the y-axis direction of the drawings. For example, the z-axis, x-axis, and y-axis may be orthogonal to each other.

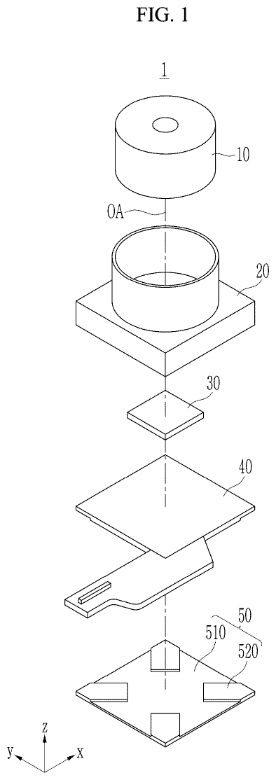

FIG. 1 is an exploded perspective view of a camera module 1 according to an embodiment.

Referring to FIG. 1, the camera module 1 according to an embodiment may include the lens barrel 10, a housing 20, an image sensor 30, a substrate 40, and a reinforcing member 50.

The lens barrel 10 may accommodate at least one lens therein. The lens barrel 10 may have a hollow cylindrical shape so that at least one lens for photographing a subject may be accommodated therein. When lenses are provided in a plural quantity, the plurality of lenses may be mounted on the lens barrel 10 along the optical axis OA. The plurality of lenses may be arranged in a required number according to the design of the lens barrel 10, and respective lenses may have the same or different optical characteristics such as a refractive index.

The housing 20 may accommodate the lens barrel 10 therein. For example, the housing 20 may have a structure of which an upper portion and a lower portion is open. The housing 20 may serve to protect internal components of the camera module 1. In addition, the housing 20 may serve to shield electromagnetic waves so that the electromagnetic waves having occurred in the camera module 1 may not affect other electronic devices. The substrate 40 on which the image sensor 30 is mounted may be disposed on a lower side of the housing 20.

The image sensor 30 may be disposed on a first side of the lens barrel 10 in the direction of the optical axis OA of the lens barrel 10. The image sensor 30 may convert incident light that has passed through the lens into an electric signal. For example, the image sensor 30 may be a charge-coupled device (CCD), a complementary metal-oxide semiconductor (CMOS), or the like. The electric signal converted by the image sensor 30 may be output as an image through a display unit of an electronic device such as a smartphone. The image sensor 30 may be mounted on the substrate 40.

The image sensor 30 may be electrically connected to the substrate 40. For example, the image sensor 30 may be directly connected to the substrate 40 by wire bonding or the like. Both ends of the wire may be attached to a connection terminal of the image sensor 30 and a connection terminal of the substrate 40, respectively.

A first end of the substrate 40 may have a structure extending toward the outside of the housing 20 in order to be connected to an external circuit. The substrate 40 may be a flexible printed circuit board (FPCB), or the like. For example, the substrate 40 may be one of a flexible resin substrate of polyimide or the like, a rigid-flexible PCB (RFPCB), or a two-layered flexible printed circuit board (two Layered FPCB), but is not limited thereto.

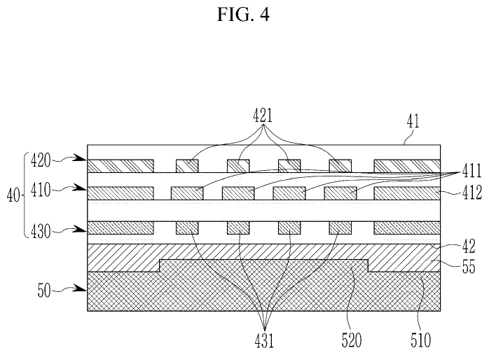

The reinforcing member 50 may be disposed on a first side of the substrate 40. Based on the substrate 40, the reinforcing member 50 may be disposed on the opposite side from the lens barrel 10. Along the direction of the optical axis OA, the reinforcing member 50 may be disposed in a lower side of the substrate 40. The reinforcing member 50 may be bonded to a lower surface of the substrate 40. For example, the reinforcing member 50 may be bonded to the lower surface of the substrate 40 through an adhesive layer 55 (see FIG. 4). The reinforcing member 50 may support the substrate 40, so that the substrate 40 may be prevented from being deformed or damaged by external force. The reinforcing member 50 may be provided as a stainless steel material or the like.

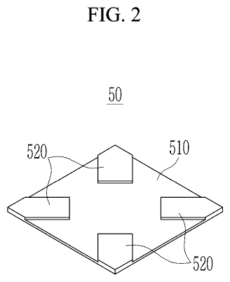

FIG. 2 is a drawing showing the reinforcing member 50 of FIG. 1.

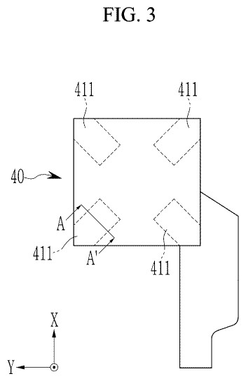

Referring to FIG. 2, the reinforcing member 50 may be provided to have different thicknesses depending on regions. For example, the reinforcing member 50 may include a first region 510 and a second region 520. The first region 510 and the second region 520 may have a predetermined thickness. The first region 510 and the second region 520 may have different thicknesses. A thickness of the second region 520 may be provided to be thicker than a thickness of the first region 510. FIG. 2 illustrates an example in which the second region 520 is located in each edge region of the reinforcing member 50 so that four second regions 520 are provided. However, this may be merely an example, and the number of the second region 520, the location of the second region 520, and the area of the second region 520 may vary. That is, the second region 520 may be provided to be located on a lower side of a main signal layer 411 (see FIG. 3) to be described later. At this time, the main signal layer 411 may be provided in a main circuit layer 410 as one region, or may be located apart from each other as a plurality of regions. That is, the location, area, quantity, or the like of the main signal layer 411 may be different depending on the design condition of the substrate 40. In addition, the second region 520 may be located on the reinforcing member 50 in a quantity of at least one, to be located on the lower side of the main signal layer 411.

FIG. 3 is a drawing showing the substrate 40 to which the reinforcing member 50 is attached, and FIG. 4 is a cross-sectional view taken along line A-A′ of FIG. 3.

Referring to FIG. 3 and FIG. 4, the substrate 40 may include the main circuit layer 410, an upper conductive layer 420 and a lower conductive layer 430.

The substrate 40 may include a first surface 41 and a second surface 42 located in opposite directions. The first surface 41 may face the lens barrel 10. The second surface 42 may face the reinforcing member 50. Hereinafter, the first surface 41 may be referred to as an upper surface of the substrate 40, and the second surface 42 may be referred to as the lower surface of the substrate 40. In addition, a direction in which the first surface 41 is located relative to the second surface 42 may be referred to as an upper side.

The main circuit layer 410 may be located in an interior of the substrate 40. The main circuit layer 410 may include the main signal layer 411 and a non-signal layer 412. The main signal layer 411 may form a path for transferring signals. For example, the main signal layer 411 may provide a path along which the signal transferred from the image sensor 30 moves. The main signal layer 411 may include a plurality of line structures. In addition, the main signal layer 411 may include at least one plate structure in a partial region.

The non-signal layer 412 may be located around the main signal layer 411. The non-signal layer 412 may be coplanar with the main circuit layer 410. The non-signal layer 412 may be electrically grounded.

The upper conductive layer 420 may be located on an upper side of the main circuit layer 410. The upper conductive layer 420 may include an upper mesh layer 421. The upper mesh layer 421 may be located to overlap with the main signal layer 411 in a vertical direction. The upper mesh layer 421 may have a lattice structure or porous structure of a metallic material. In addition, an insulation layer located to fill the space between the upper mesh layers 421 may be disposed in a mesh structure or a porous structure, and the upper mesh layer 421 may have a dot structure. By the upper mesh layer 421, the impedance value around the main signal layer 411 may be adjusted.

The lower conductive layer 430 may be located on a lower side of the main circuit layer 410. The lower conductive layer 430 may include a lower mesh layer 431. The lower mesh layer 431 may be located to overlap with the main signal layer 411 in the vertical direction. The lower mesh layer 431 may have a lattice structure or porous structure of a metallic material. In addition, an insulation layer located to fill the space between the lower mesh layer 431 may be disposed in a mesh structure or porous structure, and the lower mesh layer 431 may have a dot structure. By the lower mesh layer 431, the impedance value around the main signal layer 411 may be adjusted.

When the reinforcing member 50 is attached to the substrate 40, the second region 520 may overlap with a lower surface 42 of the substrate 40 in the vertical direction. That is, an entire region of the second region 520 may overlap with the lower surface of the substrate 40 in the vertical direction. In addition, at least a partial region of the first region 510 may overlap with the lower surface 42 of the substrate 40 in the vertical direction. For example, an entire region of the first region 510 may overlap with the lower surface 42 of the substrate 40 in the vertical direction.

The second region 520 may be located below a region where the main signal layer 411 is located. The second region 520 may be located to overlap with the main signal layer 411 in the vertical direction. The second region 520 may be located to be aligned with the main signal layer 411 in the vertical direction. In addition, the second region 520 may be located to overlap with the upper mesh layer 421 in the vertical direction. The second region 520 may be located to be aligned with the upper mesh layer 421 in the vertical direction. In addition, the second region 520 may be located to overlap with the lower mesh layer 431 in the vertical direction. The second region 520 may be located to be aligned with the lower mesh layer 431 in the vertical direction.

The thickness of the adhesive layer 55 may be different depending on regions. The thickness of the adhesive layer 55 may be thinner in the region located on the second region 520 of the reinforcing member 50 than in the region located on the first region 510 of the reinforcing member 50.

FIG. 4 illustrates an example in which the substrate 40 includes the upper mesh layer 421 and the lower mesh layer 431, but one of the upper mesh layer 421 and the lower mesh layer 431 may be omitted.

Distortion of the substrate 40 may be prevented or minimized in the camera module 1 according to an embodiment. The substrate 40 may include a region provided with a conductive material such as copper, and a region provided with an insulation material. At this time, in the substrate 40, arrangement form and distribution ratio of the conductive region and the insulating region may be different depending on regions. Accordingly, stress may internally occur in the substrate 40 depending on the difference in the distribution ratio of materials depending on regions. In addition, depending on the distribution form of the conductive region and the insulating region, the substrate 40 may show the level of thermal expansion due to heat occurring during the operation to be varied depending on regions. In addition, the difference in the level of expansion depending on regions may cause the distortion of the substrate 40. According to the camera module 1 according to an embodiment, the reinforcing member 50 may compensate for distortion of the substrate 40. Specifically, the distribution difference of the material of the substrate 40 depending on regions may occur significantly between the main signal layer 411 and other regions. For example, mesh layers 421 and 431 may be located on the upper side or the lower side of the main signal layer 411. The mesh layers 421 and 431 may increase the distribution density of the conductive material than an adjacent region located coplanar thereto. Corresponding thereto, the reinforcing member 50 may have a thickness difference between a region located in the lower side of the main signal layer 411 and a region other than that, thereby adjusting the force acting between the reinforcing member 50 and the substrate 40 to prevent or minimize distortion of the substrate 40.

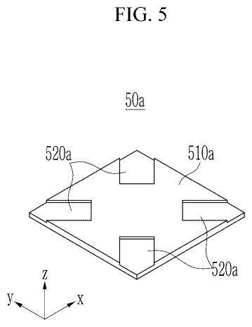

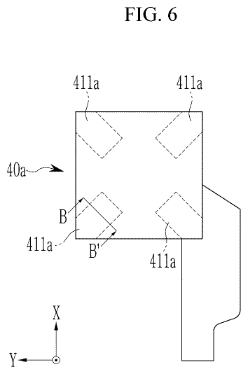

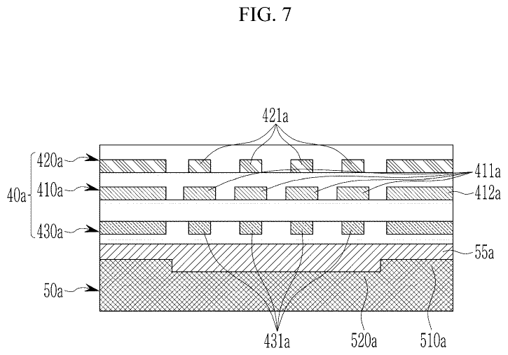

FIG. 5 is a drawing showing a reinforcing member 50a according to another embodiment, FIG. 6 is a drawing showing the substrate 40a to which the reinforcing member 50a of FIG. 5 is attached, and FIG. 7 is a cross-sectional view taken along line B-B′ of FIG. 6.

Referring to FIG. 5 to FIG. 7, the reinforcing member 50a may be provided to have different thicknesses depending on regions. For example, the reinforcing member 50a may include a first region 510a and a second region 520a. The first region 510a and the second region 520a may have a predetermined thickness. The first region 510a and the second region 520a may have different thicknesses. A thickness of the second region 520a may be provided to be thinner than the thickness of the first region 510a. FIG. 5 illustrates an example in which the second region 520a is located in each edge region of the reinforcing member 50a so that four second regions 520a are provided. However, this may be merely an example, and in the same or similar way as described above in FIG. 2, the number of the second region 520a, the position of the second region 520a, and the area of the second region 520a may be different depending on the design condition of the substrate 40a.

The substrate 40a may include a main circuit layer 410a, an upper conductive layer 420a and a lower conductive layer 430a.

The main circuit layer 410a may include a main signal layer 411a and a non-signal layer 412a.

The upper conductive layer 420a may include an upper mesh layer 421a.

The lower conductive layer 430a may include a lower mesh layer 431a.

FIG. 7 illustrates an example in which the substrate 40a includes the upper mesh layer 421a and the lower mesh layer 431a, but one of the upper mesh layer 421a and the lower mesh layer 431a may be omitted. The structure of the substrate 40a is the same as or similar to the substrate 40 described above with reference to FIG. 3 and FIG. 4, and the repeated description will not be included here again.

When the reinforcing member 50a is attached to the substrate 40a, the second region 520a may overlap with the lower surface of the substrate 40a in the vertical direction. That is, an entire region of the second region 520a may overlap with the lower surface of the substrate 40a in the vertical direction. In addition, at least a partial region of the first region 510a may overlap with the lower surface of the substrate 40a in the vertical direction. For example, an entire region of the first region 510a may overlap with the lower surface of the substrate 40a in the vertical direction.

The second region 520a may be located below a region where the main signal layer 411a is located. The second region 520a may be located to overlap with the main signal layer 411a in the vertical direction. The second region 520a may be located to be aligned with the main signal layer 411a in the vertical direction. In addition, the second region 520a may be located to overlap with the upper mesh layer 421a in the vertical direction. The second region 520a may be located to be aligned with the upper mesh layer 421a in the vertical direction. In addition, the second region 520a may be located to overlap with the lower mesh layer 431a in the vertical direction. The second region 520a may be located to be aligned with the lower mesh layer 431a in the vertical direction.

The thickness of an adhesive layer 55a may be different depending on regions. The thickness of the adhesive layer 55a may be thicker in the region located on the second region 520a of the reinforcing member 50a than in the region located on the first region 510a of the reinforcing member 50a.

The distortion may be prevented or minimized in the substrate 40a to which the reinforcing member 50a according to the present embodiment is attached. The substrate 40a may have distortion according to the difference of the material depending on regions. In addition, the substrate 40a may show different distortion pattern depending on the material used in the conductive region and the material used in the insulating region. Accordingly, the reinforcing member 50a according to the present embodiment may be thin in the region located on a lower side of the main signal layer 411a, and may be thick in other regions.

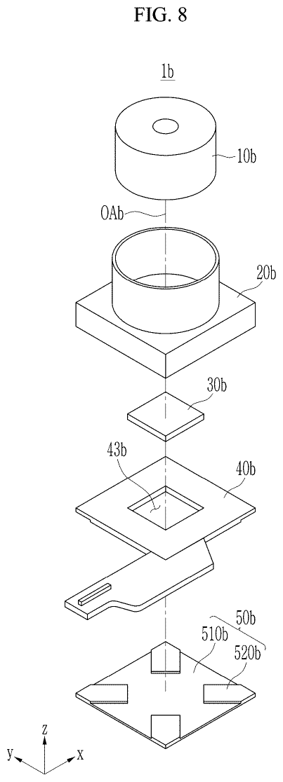

FIG. 8 is a drawing showing a camera module 1b according to another embodiment.

Referring to FIG. 8, the camera module 1b according to another embodiment may include a lens barrel 10b, a housing 20b, an image sensor 30b, a substrate 40b and a reinforcing member 50b.

The lens barrel 10b, the housing 20b, and the image sensor 30b are the same as or similar to the lens barrel 10, the housing 20, and the image sensor 30 described above with reference to FIG. 1, and the repeated description will not be included here again.

A first end of the substrate 40b may have a structure extending toward the outside of the housing 20b in order to be connected to an external circuit. The substrate 40b may be a flexible printed circuit board (FPCB), or the like. For example, the substrate 40b may be one of a flexible resin substrate of polyimide or the like, a rigid-flexible PCB (RFPCB), or a two-layered flexible printed circuit board (two Layered FPCB), but is not limited thereto.

The substrate 40b may have an opening 43b in a central region. The opening 43b may be provided to penetrate both surfaces of the substrate 40b. Accordingly, spaces located on both surfaces of the substrate 40b in the direction of the optical axis OAb through the opening 43b may be connected to each other. The opening 43b may have a shape corresponding to the image sensor 30b. An area of the opening 43b may be provided to be greater than or equal to an area of the image sensor 30b. Accordingly, the image sensor 30b may be disposed within the opening 43b.

After the image sensor 30b is disposed in the opening 43b of the substrate 40b, the image sensor 30b and the substrate 40b may be electrically connected, thereby maximizing the space efficiency, and reducing the size of the camera module 1b.

The reinforcing member 50b may be disposed on a first side of the substrate 40b. Based on the substrate 40b, the reinforcing member 50b may be disposed on the opposite side from the lens barrel 10b. Along the direction of the optical axis OAb, the reinforcing member 50b may be disposed in a lower side of the substrate 40b. The reinforcing member 50b may be bonded to a lower surface of the substrate 40b. For example, the reinforcing member 50b may be bonded to the lower surface of the substrate 40b through an adhesive layer. The reinforcing member 50b may support the substrate 40b, so that the substrate 40b may be prevented from being deformed or damaged by external force. The reinforcing member 50b may be provided as a stainless steel material or the like.

The reinforcing member 50b may be provided to have different thicknesses depending on regions. For example, the reinforcing member 50b may include a first region 510b and a second region 520b. The first region 510b and the second region 520b may have different thicknesses. At this time, the second region 520b may be provided to be thicker than the first region 510b. At this time, the reinforcing member 50b may have the same or similar structure as the reinforcing member 50 described above with reference to FIG. 2 to FIG. 4, and the repeated description will not be included here again.

In addition, the second region 520b may be provided to be thinner than the first region 510b. At this time, the reinforcing member 50b may have the same or similar structure as the reinforcing member 50a described above with reference to FIG. 5 to FIG. 7, and the repeated description will not be included here again.

When the reinforcing member 50b is attached to the substrate 40b, a part of the first region 510b may overlap with the lower surface of the substrate 40b in the vertical direction, and a remainder of the first region 510b may overlap with the opening 43b in the vertical direction. Accordingly, when the reinforcing member 50b is attached to the substrate 40b, the image sensor 30b disposed in the opening 43b may be located on the first region 510b of the reinforcing member 50b.

When the reinforcing member 50b is attached to the substrate 40b, the second region 520b may overlap with the lower surface of the substrate 40b in the vertical direction. That is, an entire region of the second region 520b may overlap with the lower surface of the substrate 40b in the vertical direction.

The process of preventing or minimizing distortion of the substrate 40 by the reinforcing member 50b is the same as or similar to what was described with reference to FIG. 1 to FIG. 7, and the repeated description will not be included here again.

According to one or more embodiments as disclosed herein, a camera module capable of preventing or minimizing distortion of the substrate may be provided.

While specific examples have been shown and described above, it will be apparent after an understanding of this disclosure that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A camera module, comprising:
an image sensor configured to convert an incident light into an electric signal;
a substrate electrically connected to the image sensor, and comprising a main circuit layer; and
a reinforcing member configured to support the substrate, and having a strength reinforcing portion,
wherein the main circuit layer comprises a main signal layer forming a path for transferring signals,
wherein the reinforcing member comprises a first region and a second region having different thicknesses, and
wherein the second region is disposed to overlap with the main signal layer in a vertical direction.

2. The camera module of claim 1, wherein:
the substrate comprises an upper conductive layer disposed on an upper side of the main circuit layer; and
the upper conductive layer comprises an upper mesh layer.

3. The camera module of claim 2, wherein the upper mesh layer is disposed to overlap with the main signal layer and the second region of the reinforcing member in the vertical direction.

4. The camera module of claim 1, wherein:
the substrate comprises a lower conductive layer disposed on a lower side of the main circuit layer; and
the lower conductive layer comprises a lower mesh layer.

5. The camera module of claim 4, wherein the lower mesh layer is disposed to overlap with the main signal layer and the second region of the reinforcing member in the vertical direction.

6. The camera module of claim 1, wherein a thickness of the first region is thinner than a thickness of the second region.

7. The camera module of claim 1, wherein a thickness of the first region is thicker than a thickness of the second region.

8. The camera module of claim 1, wherein the main circuit layer further comprises a non-signal layer disposed around the main signal layer.

9. The camera module of claim 8, wherein the non-signal layer is grounded.

10. A camera module, comprising:
an image sensor configured to convert an incident light into an electric signal;
a substrate electrically connected to the image sensor; and
a reinforcing member configured to support the substrate, and having a strength reinforcing portion,
wherein the reinforcing member comprises a first region and a second region having different thicknesses, and
wherein an entire region of the first region and an entire region of the second region overlaps with the substrate in a vertical direction.

11. The camera module of claim 10, wherein:
the substrate comprises a main circuit layer;
the main circuit layer comprises a main signal layer forming a path for transferring signals; and
the second region is disposed to overlap with the main signal layer in the vertical direction.

12. The camera module of claim 10, wherein a thickness of the first region is thinner than a thickness of the second region.

13. The camera module of claim 10, wherein a thickness of the first region is thicker than a thickness of the second region.

14. A camera module, comprising:
an image sensor configured to convert an incident light into an electric signal;
a substrate electrically connected to the image sensor, and having a central region where an opening is formed; and
a reinforcing member configured to support the substrate, and having a strength reinforcing portion,
wherein the reinforcing member comprises a first region and a second region having different thicknesses, and
wherein a part of the first region overlaps with the substrate in a vertical direction, and a remainder of the first region overlaps with the opening in the vertical direction.

15. The camera module of claim 14, wherein:
the substrate comprises a main circuit layer;
the main circuit layer comprises a main signal layer forming a path for transferring signals; and
the second region is disposed to overlap with the main signal layer in the vertical direction.

16. The camera module of claim 14, wherein a thickness of the first region is thinner than a thickness of the second region.

17. The camera module of claim 14, wherein a thickness of the first region is thicker than a thickness of the second region.
